(19) United States
(12) Patent Application Publication
(10) Pub. No.: US 2005/0015452 A1
(43) Pub. Date: Jan. 20, 2005

(54) Methods and systems for training content filters and resolving uncertainty in content filtering operations

(75) Inventor: Gregory Corson, Foster City, CA (US)

Correspondence Address: MARTINE & PENILLA, LLP, 710 LAKEWAY DRIVE, SUITE 170, SUNNYVALE, CA, 94085, US

(73) Assignee: Sony Computer Entertainment Inc., Tokyo (JP)

(21) Appl. No.: 10/856,216

(22) Filed: May 27, 2004

Related U.S. Application Data
(60) Provisional application No. 60/476,084, filed on Jun. 4, 2003.

(51) Int. Cl. G06F 15/16

(52) U.S. Cl. 709/206

(57) ABSTRACT

A method for resolving uncertainty resulting from content filtering operations is provided. Results produced by a plurality of filters are received whereby the results include classification of filtered data and identification of uncertainty in the classification. Thereafter, relationships between the plurality of filters are established and the relationships are applied. The application of the relationships enables the identification of uncertainty to be resolved. Systems for resolving the uncertainty resulting from content filtering operations are also described.

### CROSS REFERENCE TO RELATED APPLICATION

This application claims the benefit of U.S. Provisional Application No. 60/476,084, filed Jun. 4, 2003. The disclosure of the provisional application is incorporated herein by reference.

### BACKGROUND OF THE INVENTION

1. Field of the Invention

The present invention relates to computer filters and, more particularly, to methods and systems for resolving non-classifiable information in filtering operations.

2. Description of the Related Art

The development of the Internet, emails, and sophisticated computer programs created a large quantity of information available to a user. A filter assists the user to efficiently process and organize large amounts of information. Essentially, a filter is a program code that examines information for certain qualifying criteria and classifies the information accordingly. For example, a picture filter is a program used to detect and categorize faces (e.g., categories include happy facial expressions, sad facial expressions, etc.) in photographs.

The problem with filters is that the filters sometimes cannot categorize certain information because the filters are not programmed to consider that particular information. For instance, the picture filter described above is trained to recognize and categorize happy facial expressions and sad facial expressions only. If a photograph of a frustrated facial expression is provided to the picture filter, the picture filter cannot classify the frustrated facial expression because the picture filter is trained to recognize happy and sad facial expressions only.

As a result, there is a need to provide methods and systems to resolve the uncertainty in the classification of information resulting from filtering operations.

### SUMMARY OF THE INVENTION

Broadly speaking, the present invention fills these needs by providing methods and systems for resolving uncertainty resulting from content filtering operations. It should be appreciated that the present invention can be implemented in numerous ways, including as a process, an apparatus, a system, computer readable media, or a device. Several inventive embodiments of the present invention are described below.

In accordance with a first aspect of the present invention, a method for resolving uncertainty resulting from content filtering operations is provided. In this method, data is first received and processed through a plurality of filters. Each of the plurality of filters is capable of producing results, the results including classification of the filtered data and identification of uncertainty in the classification. Subsequently, the results from each of the plurality of filters are processed and the processing of the results is configured to produce relationships between the plurality of filters. Thereafter, the produced relationships are applied back to any one of the plurality of filters that produced the results that included identification of uncertainty in the classification. The application of the produced relationships is used to resolve the identification of uncertainty.

In accordance with a second aspect of the present invention, a computer readable medium having program instructions for resolving uncertainty resulting from content filtering operations is provided. This computer readable medium provides program instructions for receiving results produced by a plurality of filters. The results include classification of filtered data and identification of uncertainty in the classification. Thereafter, the computer readable medium provides program instructions for establishing relationships between the plurality of filters and program instructions for applying the relationships. The application of the relationships enables the identification of uncertainty to be resolved.

In accordance with a third aspect of the present invention, a system for resolving uncertainty resulting from content filtering operations is provided. The system includes a memory for storing a relationship processing engine and a central processing unit for executing the relationship processing engine stored in the memory. The relationship processing engine includes logic for receiving results produced by a plurality of filters, the results including classification of filtered data and identification of uncertainty in the classification; logic for establishing relationships between the plurality of filters; and logic for applying the relationships, the application of the relationships enabling the identification of uncertainty to be resolved.

In accordance with a fourth aspect of the present invention, a system for resolving uncertainty resulting from content filtering operations is provided. The system includes a plurality of filtering means for processing data whereby each of the plurality of filtering means is capable of producing results. The results include classification of the filtered data and identification of uncertainty in the classification. The system additionally includes relationship processing means for processing the results from each of the plurality of filtering means. Additionally, the relationship processing means applies the produced relationships back to any one of the plurality of filtering means that produced the results that included identification of uncertainty in the classification. The processing of the results is configured to produce relationships between the plurality of filtering means and the application of the produced relationships is used to resolve the identification of uncertainty.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified block diagram of a filter, in accordance with one embodiment of the present invention.

FIG. 2 is a simplified block diagram of a system for resolving the uncertainty resulting from content filtering operations, in accordance with one embodiment of the present invention.

FIG. 3 is a flowchart diagram of a high level overview of the method operations for resolving uncertainty resulting from content filtering operations, in accordance with one embodiment of the present invention.

FIG. 4 is a flowchart diagram of the detailed method operations for resolving uncertainty resulting from content filtering operations, in accordance with one embodiment of the present invention.

FIG. 5 is a simplified diagram of an exemplary graphic user interface (GUI) that allows a user to manually establish relationships, in accordance with one embodiment of the present invention.

FIG. 6A is a simplified block diagram of an exemplary processing of results and production of relationships, in accordance with one embodiment of the present invention.

FIG. 6B is a flowchart diagram of an exemplary processing of results and application of the relationships produced in FIG. 6A, in accordance with one embodiment of the present invention.

### DETAILED DESCRIPTION

An invention is disclosed for methods and systems for resolving uncertainty resulting from content filtering operations. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

Filters cannot classify certain data and the embodiments described herein provide methods and systems for resolving the uncertainty in the classification of data. As will be explained in more detail below, the uncertainty in the classification is resolved by using relationships between the filters. In one embodiment, a computer automatically produces the relationships between the filters. In another embodiment, a user manually specifies to the computer the relationships between the filters.

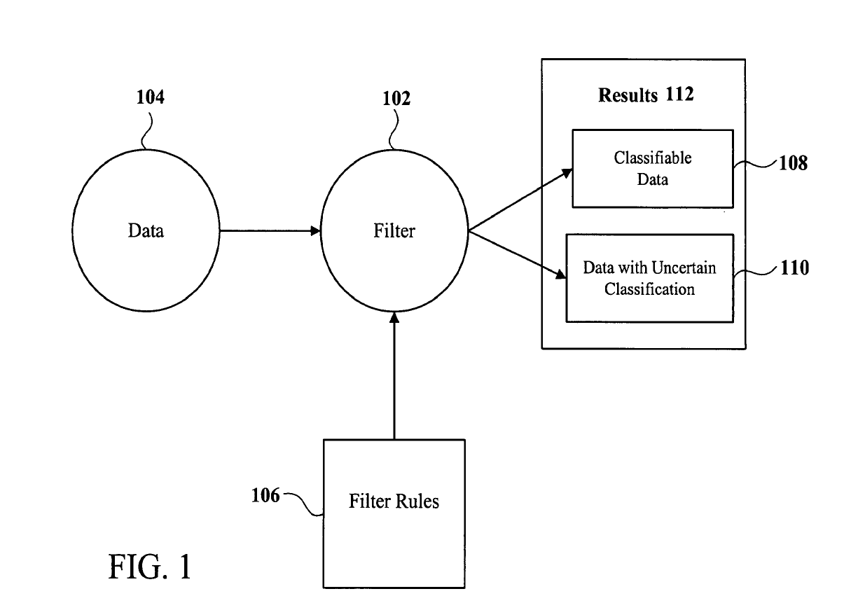

FIG. 1 is a simplified block diagram of a filter, in accordance with one embodiment of the present invention. As is well known to those skilled in the art, filter 102 is a program code that examines data 104 for certain qualifying criteria and classifies the data accordingly. For example, a spam email filter is a program used to detect unsolicited emails and to prevent the unsolicited emails from getting to a user's email inbox. Like other types of filtering programs, the spam email filter looks for certain qualifying criteria on which the spam email filter bases its judgments. For instance, a simple version of the spam email filter is programmed to watch for particular words in a subject line of email messages and to exclude email with the particular words from the user's email inbox. More sophisticated spam email filters, such as Bayesian filters and other heuristic filters, attempt to identify spam email through suspicious word patterns or word frequency. Other exemplary filters include email filters that identify spam, personal mail, or classify mail by subject; filters that find and identify faces or specific objects (e.g., cars, houses, etc.) in pictures; filters that listen to music and identify the title of the song, group, etc.; filters that identify a type of web page such as a blog, a news page, a weather page, a financial page, a magazine page, etc.; filters that identify the person speaking in an audio recording; filters that identify spelling errors in text documents; and filters that identify the subjects/topics of a text document.

As shown in FIG. 1, filter 102 processes both data 104 and filter rules 106 to produce results 112. In other words, filter 102 examines data 104 for certain qualifying criteria and classifies the data accordingly. Data 104 are numerical or any other information represented in a form suitable for processing by a computer. Exemplary data 104 include email messages, program files, picture files, sounds files, movie files, web pages, word processing texts, etc. Additionally, data 104 may be received from any suitable source. Exemplary sources include networks (e.g., the Internet, local-area networks (LAN), wide-area networks (WAN), etc.), programs (e.g., video games, a work processors, drawing programs, etc.), databases, etc.

The qualifying criteria as discussed above are based on filter rules 106. Filter rules 106 are instructions that specify procedures to process data 104 and specify what data are allowed or rejected. For example, a filter rule for the spam email filter discussed above specifies the examination of particular words in the subject lines of email messages and the exclusion of emails with the particular words in their subject lines.

As a result of processing data 104 and filter rules 106, filter 102 produces results 112. Results 112 include classifiable data 108 and data with uncertain classification 110. Classifiable data 108 are data particularly considered by filter rules 106. For instance, an exemplary filter rule for the spam email filter discussed above specifies the inclusion of emails with a particular word “dear” in the subject lines. Such emails are classified as non-spam. However, emails with a particular word “purchase” in the subject lines are classified as spam and excluded. Since emails with the particular words “dear” and “purchase” in the subject lines are particularly considered by filter rules 106, all emails with the particular words “dear” and “purchase” in the subject lines are classifiable data 108.

On the other hand, data with uncertain classification 110 are data not particularly considered by filter rules 106. In other words, data with uncertain classification 110 are non-classifiable data. For instance, the above-discussed exemplary filter rule considers the particular words “dear” and “purchase” in the subject lines. Email messages without the particular words “dear” and “purchase” in the subject lines cannot be classified by filter 102 as spam or non-spam. Therefore, email messages without the particular words “dear” and “purchase” in the subject lines are data with uncertain classification 110.

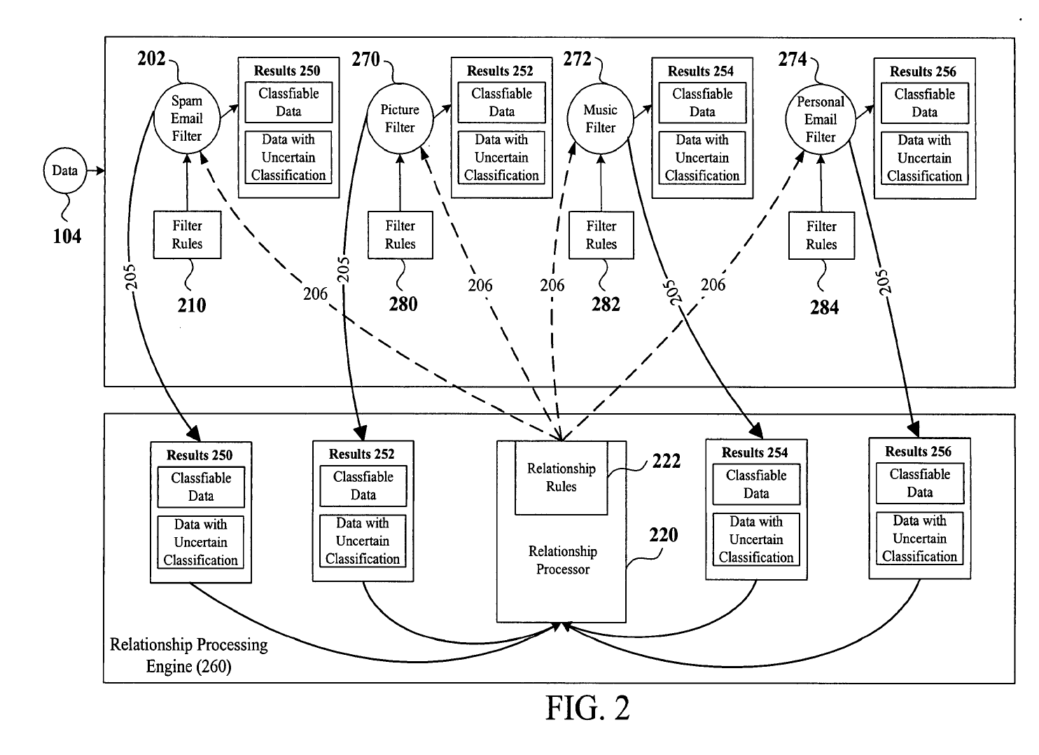

FIG. 2 is a simplified block diagram of a system for resolving the uncertainty resulting from content filtering operations, in accordance with one embodiment of the present invention. As shown in FIG. 2, the system includes spam email filter 202, picture filter 270, music filter 272, personal email filter 274, and relationship processing engine 260. Filters 202, 270, 272, and 274 process both data 104 and filter rules 210, 280, 282, and 284 to produce results 250, 252, 254, and 256.

In particular, results 250, 252, 254, and 256 are provided 205 to relationship processing engine 260. In one embodiment, results 250, 252, 254, and 256 are stored in a database such that the results may be searchable. Subsequently, relationship processor 220 included in relationship processing engine 260 processes results 250, 252, 254, and 256 from filters 202, 270, 272, and 274 to produce relationships between the filters. Although FIG. 2 shows four filters 202, 270, 272, and 274, relationship processor 220 can process any number of filters. As will be explained in more detail below, the produced relationships are relationship rules 222 between results 250, 252, 254, and 256. In one embodiment, relationship rules 222 are manually established by a user. In another embodiment, relationship rules 222 are automatically determined by relationship processing engine 260. For example, relationship processing engine 260 records a sequence of user actions made when interfacing with filters 202, 270, 272, and 274. Exemplary user actions include deleting certain emails, consistently rejecting certain pictures, moving certain messages to one category, consistently classifying certain emails, etc. Such user actions may form relationship patterns and relationship processor 220 automatically recognizes these relationship patterns between filters 202, 270, 272, and 274 to enable relationships between the filters to be established automatically.

After the relationships between filters 202, 270, 272, and 274 are established, relationship processor 220 formulates and stores the relationships as relationship rules 111. Relationship processor 220 then automatically resolves the identity of data with uncertain classification by applying the relationships. Thereafter, relationship processing engine 250 applies the resolved identity in the classification back 206 to any one of filters 202, 270, 272, and 274 that produced results 250, 252, 254, and 256 that included the data with uncertain classification.

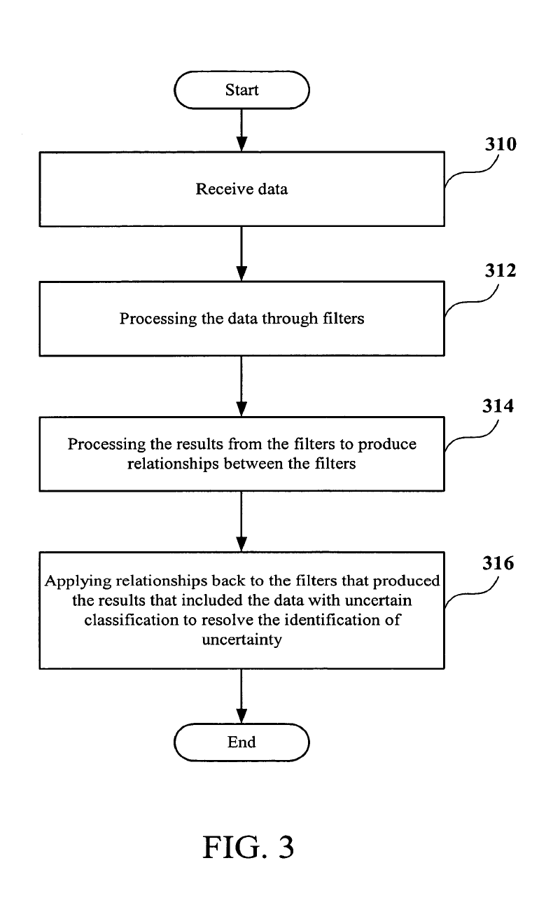

FIG. 3 is a flowchart diagram of a high level overview of the method operations for resolving uncertainty resulting from content filtering operations, in accordance with one embodiment of the present invention. Starting in operation 310, filters, which may be designed to classify data in different ways, receive data and, in operation 312, process the data to produce results. The results include classification of the filtered data and identification of filtered data with uncertain classification.

Thereafter, in operation 314, a relationship processing engine processes the results produced by each of the filters to produce relationships between the filters in operation 316. The produced relationships are then applied back to any one of the filters that produced the results that included the identification of uncertainty in the classification. The application of the produced relationships is used to resolve the identification of uncertainty.

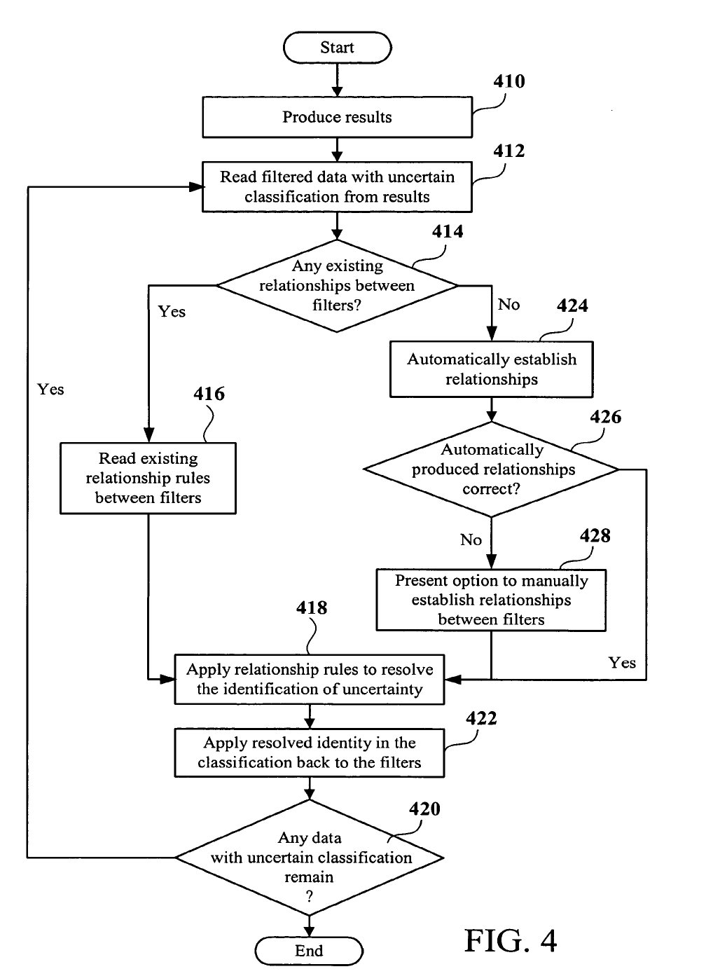

FIG. 4 is a flowchart diagram of the detailed method operations for resolving uncertainty resulting from content filtering operations, in accordance with one embodiment of the present invention. Starting in operation 410, filters process both data and filter rules to produce results. Results include classifiable data and data with uncertain classification. In operation 412, the filtered data with uncertain classification are then read from the results. Any existing relationships between the filters are first checked in operation 414. If there are relevant, existing relationships between the filters, the relationship rules are read in operation 416 and applied in operation 418 to resolve the identification of the uncertainty.

On the other hand, if relationships between the filters do not exist, then the relationships are automatically established in operation 424. As discussed above, in one embodiment, the relationships may be automatically produced by analyzing user actions. Thereafter, in operation 426, a user is asked to confirm the automatically produced relationships. If the user confirms that the automatically produced relationships are correct, then the relationship rules are applied in operation 418 to resolve the identification of the uncertainty. However, if the user specifies that the automatically produced relationships are incorrect, then the user is given an option to manually establish the relationships in operation 428. After the user manually establishes the relationships, the relationships are formulated into relationship rules. The relationship rules are then applied in operation 418 to resolve the identification of uncertainty.

After the relationship rules are applied to resolve the identification of uncertainty in operation 418, the resolved identity in the classification is applied back to the filters in operation 422. A check is then conducted in operation 420 to determine whether any data with uncertain classification remain. If there are additional data with uncertain classification, then the operations described above are again repeated starting in operation 412. Else, the method operation ends.

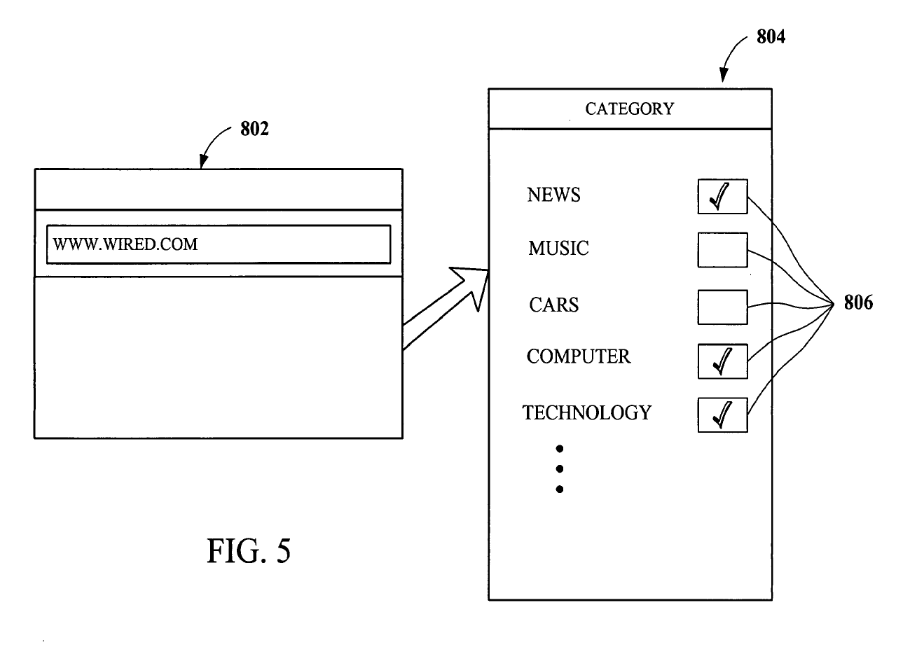

FIG. 5 is a simplified diagram of an exemplary graphic user interface (GUI) that allows a user to manually establish relationships, in accordance with one embodiment of the present invention. In one embodiment, after the relationships are automatically established, a user may be asked to confirm the automatically produced relationships. As shown in FIG. 5, the user browses web page 802 at web address “www.wired.com.” Web page 802 is processed through a variety of filters and a relationship processing engine processes the results, produces relationships between the filters, and applies the produced relationships to resolve the identification of the web page's category.

In this case, the relationship processing engine automatically determines that web page 802 belongs to news, computers, and technology categories and consequently, displays a pop-up menu region 804 listing the categories of the web page. In addition to displaying the automatically determined categories of web browser 802, pop-up menu region 804 also allows the user to manually establish the relationships between the filters. Here, for example, the user may manually establish the relationships by checking or unchecking each box 806 corresponding to each category. The user simply checks box 806 next to the corresponding category to indicate that web page 802 belongs to the referenced category. Alternatively, the user may uncheck the category to indicate that web page 802 does not belong to the referenced category. In this way, pop-up menu region 804 allows the user to confirm that the automatically established relationships are correct and, if not correct, then manually establish the relationships.

Any number of suitable layouts can be designed for region layouts illustrated above as FIG. 5 does not represent all possible layout options available. The displayable appearance of the regions can be defined by any suitable geometric shape (e.g., rectangle, square, circle, triangle, etc.), alphanumeric character (e.g., A,v,t,Q,1,9,10, etc.), symbol (e.g., $,*,@,α, [symbol] ,¤,♥, etc.), shading, pattern (e.g., solid, hatch, stripes, dots, etc.), and color. Furthermore, for example, pop-up menu region 804 in FIG. 5 may be omitted or dynamically assigned. It should also be appreciated that the regions can be fixed or customizable. In addition, the computing devices may have a fixed set of layouts, utilize a defined protocol or language to define a layout, or an external structure can be reported to a computing device that defines a layout.

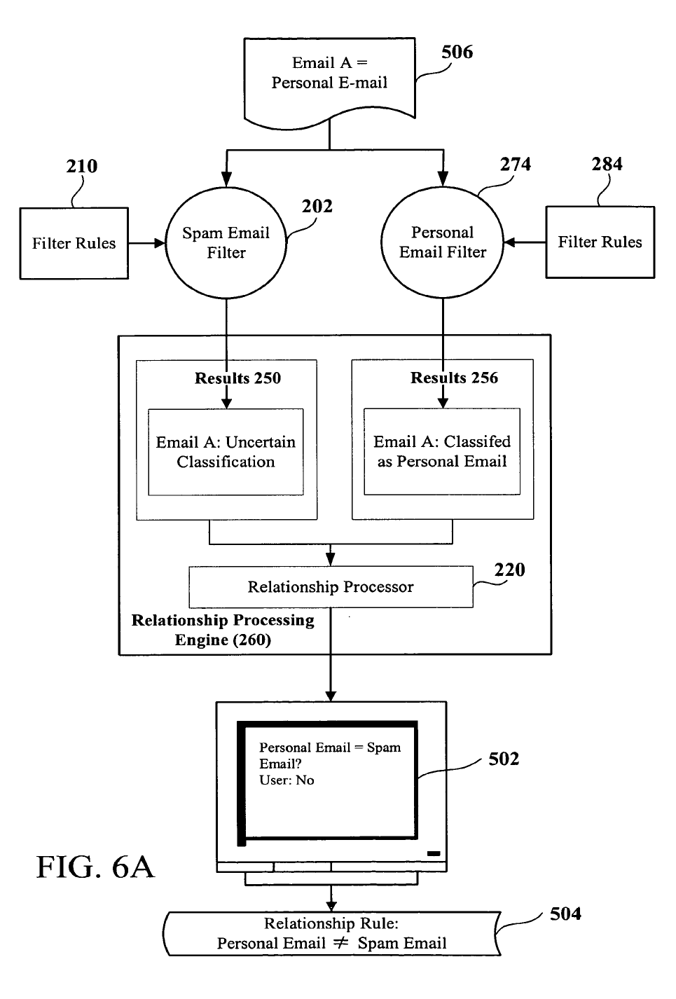

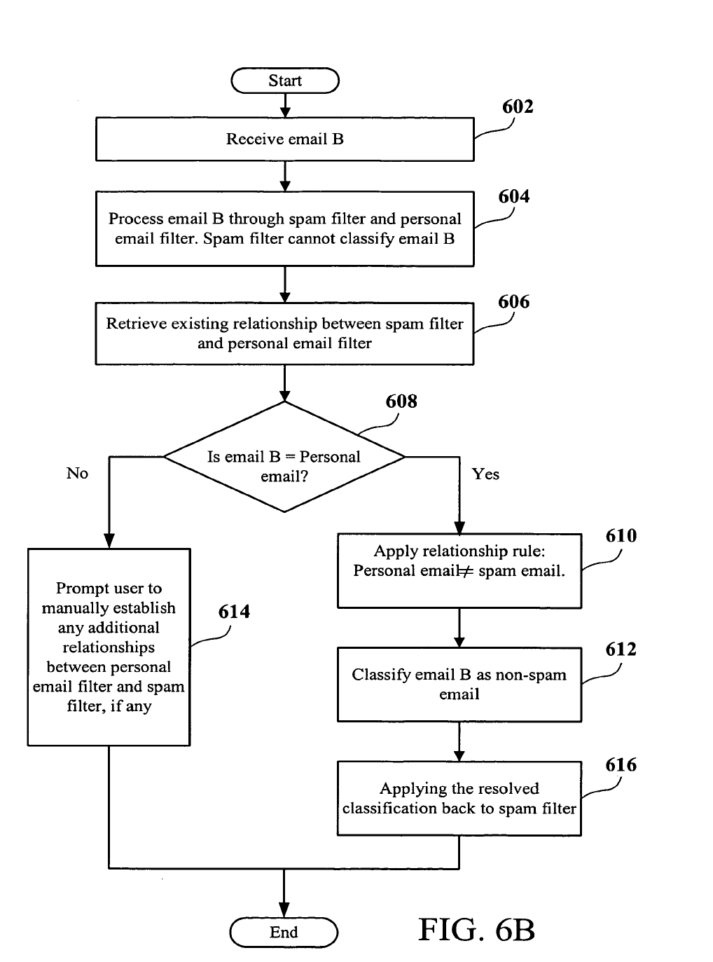

FIG. 6A is a simplified block diagram of an exemplary processing of results and production of relationships, in accordance with one embodiment of the present invention. As shown in FIG. 6A, the exemplary system includes spam email filter 202, personal email filter 274, relationship processing engine 260, and monitor 502. Spam filters 202 and personal email filter 274 process Email A 506 and filter rules 210 and 284 to produce results 250 and 256. In this example, Email A 506 is a personal email and, as a result, personal email filter 274 correctly classifies Email A 506 as personal email. However, spam email filter 202 is uncertain in the classification of Email A 506 because personal email is not considered by filter rule 210 of the spam email filter. As such, spam email filter 202 cannot classify Email A 506 and results 250 produced by the spam email filter identifies Email A with uncertain classification.

Relationship processing engine 260 then processes results 250 and 256 to establish one or more relationships between spam email filter 202 and personal email filter 274. In one embodiment, a user manually establishes the relationships. In this case, as shown on monitor 502, relationship processing engine 260 asks the user whether personal email is equal to spam email. The user manually specifies that personal email is not equal to spam email. As such, relationship processor 220 processes the user's input and results 250 and 256 to produce relationship rule 504 that personal email is not equal to spam email.

FIG. 6B is a flowchart diagram of an exemplary processing of results and application of the relationships produced in FIG. 6A, in accordance with one embodiment of the present invention. Starting in operation 602, both spam email filter and personal email filter discussed above in FIG. 6A receive an Email B, in operation 604, and process the Email B to produce results. In this case, spam email filter is uncertain as to the classification of Email B and, as such, a relationship processing engine further processes the results from spam email filter and personal email filter to resolve the classification of Email B.

The relationship processing engine determines that an existing relationship between spam email filter and personal email filter exists, which was previously established in the discussion of FIG. 6A, and retrieves the existing relationship in operation 606. According to the previously established relationship rule, personal email is not spam email. As a result, a check is conducted in operation 608 to determine whether Email B is classified as personal email. The particular relationship rule does not consider non-personal emails. Thus, if Email B is not classified as personal email, then the relationship processing engine in operation 614 prompts the user to manually establish any additional relationships between spam email filter and personal email filter to resolve the classification of Email B, in accordance with one embodiment of the present invention. In another embodiment, the relationship processing engine may produce the relationships automatically. If no additional relationships are established, then the classification of Email B with respect to the spam email filter remains unresolved.

On the other hand, if Email B is classified as personal email, then the relationship rule is applied to Email B in operation 610. Here, in operation 612, Email B is classified as non-spam email because, as discussed above, the previously established relationship rule specifies that personal email is not spam email. The resolved classification of Email B is then applied back to the spam filter in operation 616.

The above described invention provides methods and systems for training filters and resolving non-classifiable information in filtering operations. The uncertainties in classification are resolved by looking at additional relationships between filters. In addition, the result of utilizing relationships between the filters allows the filters to interact with one another. For example, a system includes email filters to identify mail from family members and face recognition filters to recognize family members' faces in pictures. The relationships between filters allow the grouping of family members in pictures with the family member's email. For instance, pictures of family members taken at various gatherings are scanned into a computer. Some of these pictures are naturally group photos containing most of, or the whole, family, and the computer would realize that there are certain pictures that always contain the same set of faces. The computer may then show a user these pictures and ask if the user wants to put these pictures in a new category. The user agrees and names the new category “whole family.” The computer then looks at other content (e.g., email, videos, audio, etc.) with the assistance of filters and automatically adds any of these contents that contain the family members to the new “whole family” category. Furthermore, after the filters have been trained and relationships established, the classified categories may be sent to an Internet search engine to find related content.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A method for resolving uncertainty resulting from content filtering operations, comprising:
receiving data;
processing the data through a plurality of filters, each of the plurality of filters capable of producing results that include classification of the filtered data and identification of uncertainty in the classification;
processing the results from each of the plurality of filters, the processing of the results being configured to produce relationships between the plurality of filters; and
applying the produced relationships back to any one of the plurality of filters that produced the results that included identification of uncertainty in the classification, the application of the produced relationships being used to resolve the identification of uncertainty.

2. The method of claim 1, wherein the production of relationships between the plurality of filters includes,
recording a sequence of user actions made when interfacing with the plurality of filters; and
recognizing patterns between the plurality of filters from the sequence of user actions, the patterns enabling relationships between the plurality of filters to be established automatically.

3. The method of claim 1, wherein the production of relationships between the plurality of filters includes,
enabling the relationships between the plurality of filters to be manually established.

4. The method of claim 1, wherein the data is defined by one or more of an e-mail message, a program file, a picture file, a sounds file, a movie file, a web page, and a word processing text.

5. The method of claim 1, wherein each of the plurality of filters is defined by one of a spam filter, a picture filter, a music filter, a personal email filter, a face recognition filter, a voice filter, a spelling filter, and a web page filter.

6. The method of claim 1, wherein the produced relationships are relationship rules between the results.

7. A computer readable medium having program instructions for resolving uncertainty resulting from content filtering operations, comprising:
program instructions for receiving results produced by a plurality of filters, the results including classification of filtered data and identification of uncertainty in the classification;
program instructions for establishing relationships between the plurality of filters; and
program instructions for applying the relationships, the application of the relationships enabling the identification of uncertainty to be resolved.

8. The computer readable medium of claim 7, further comprising:
program instructions for applying the resolved uncertainty in the classification back to any one of the plurality of filters that produced the results that included identification of uncertainty in the classification.

9. The computer readable medium of claim 7, wherein the program instructions for establishing relationships between the plurality of filters include,
program instructions for recording a sequence of user actions made when interfacing with the plurality of filters; and
program instructions for recognizing patterns between the plurality of filters from the sequence of user actions, the patterns enabling relationships between the plurality of filters to be established automatically.

10. The computer readable medium of claim 7, wherein the program instructions for establishing relationships between the plurality of filters include,
program instructions for enabling the relationships between the plurality of filters to be manually established.

11. The computer readable medium of claim 7, wherein each of the plurality of filters is a program code that examines data for certain qualifying criteria and classifies the data accordingly.

12. The computer readable medium of claim 11, wherein each of the plurality of filters is defined by one of a spam filter, a picture filter, a music filter, a personal email filter, a face recognition filter, a voice filter, a spelling filter, and a web page filter.

13. The computer readable medium of claim 11, wherein the data is defined by one or more of an e-mail message, a program file, a picture file, a sounds file, a movie file, a web page, and a word processing text.

14. The computer readable medium of claim 7, wherein the relationships are relationship rules between the results produced by the plurality of filters.

15. A system for resolving uncertainty resulting from content filtering operations, comprising:
a memory for storing a relationship processing engine; and
a central processing unit for executing the relationship processing engine stored in the memory,
the relationship processing engine including,
logic for receiving results produced by a plurality of filters, the results including classification of filtered data and identification of uncertainty in the classification,
logic for establishing relationships between the plurality of filters, and
logic for applying the relationships, the application of the relationships enabling the identification of uncertainty to be resolved.

16. The system of claim 15, further comprising:
circuitry including,
logic for receiving results produced by a plurality of filters, the results including classification of filtered data and identification of uncertainty in the classification;
logic for establishing relationships between the plurality of filters; and
logic for applying the relationships, the application of the relationships enabling the identification of uncertainty to be resolved.

17. The system of claim 15, wherein the logic for establishing relationships between the plurality of filters includes,
logic for recording a sequence of user actions made when interfacing with the plurality of filters; and
logic for recognizing patterns between the plurality of filters from the sequence of user actions, the patterns enabling relationships between the plurality of filters to be established automatically.

18. The system of claim 15, wherein the logic for establishing relationships between the plurality of filters includes,
logic for enabling the relationships between the plurality of filters to be manually established.

19. The system of claim 15, wherein the filtered data is defined by one or more of an e-mail message, a program file, a picture file, a sounds file, a movie file, a web page, and a word processing text.

20. The system of claim 15, wherein each of the plurality of filters is a program code that examines data for certain qualifying criteria and classifies the data accordingly.

21. The system of claim 20, wherein each of the plurality of filters is defined by one of a spam filter, a picture filter, a music filter, a personal email filter, and a web page filter.

22. The system of claim 15, wherein the relationships are relationship rules between the results produced by the plurality of filters.

23. A system for resolving uncertainty resulting from content filtering operations, comprising:
a plurality of filtering means for processing data, each of the plurality of filtering means capable of producing results that include classification of the filtered data and identification of uncertainty in the classification; and
relationship processing means for
processing the results from each of the plurality of filtering means, the processing of the results being configured to produce relationships between the plurality of filtering means, and
applying the produced relationships back to any one of the plurality of filtering means that produced the results that included identification of uncertainty in the classification, the application of the produced relationships being used to resolve the identification of uncertainty.

24. The system of claim 23, wherein the production of relationships between the plurality of filtering means includes,
recording a sequence of user actions made when interfacing with the plurality of filters; and
recognizing patterns between the plurality of filtering means from the sequence of user actions, the patterns enabling relationships between the plurality of filtering means to be established automatically.

25. The system of claim 23, wherein the production of relationships between the plurality of filtering means includes,
enabling the relationships between the plurality of filtering means to be manually established.

26. The system of claim 23, wherein the data is defined by one or more of an e-mail message, a program file, a picture file, a sounds file, a movie file, a web page, and a word processing text.

27. The system of claim 23, wherein each of the plurality of filtering means is defined by one of a spam filter, a picture filter, a music filter, a personal email filter, a face recognition filter, a voice filter, a spelling filter, and a web page filter.

28. The system of claim 23, wherein the produced relationships are relationship rules between the results.
